(19) United States
(12) Patent Application Publication
(10) Pub. No.: US 2005/0043653 A1
(43) Pub. Date: Feb. 24, 2005

(54) Skin cleansing and moisturizing device

(75) Inventors: William Stuart Trimmer, Hillsborough, NJ (US); Robert Steven Sears, Round Hill, VA (US)

Correspondence Address: NIXON & VANDERHYE, PC, 1100 N GLEBE ROAD, 8TH FLOOR, ARLINGTON, VA, 22201-4714, US

(73) Assignee: Azalea Way Consumer Products LLC,, Hillsborough, NJ (US)

(21) Appl. No.: 10/921,883

(22) Filed: Aug. 20, 2004

Related U.S. Application Data
(60) Provisional application No. 60/496,695, filed on Aug. 21, 2003.
(60) Provisional application No. 60/508,235, filed on Oct. 3, 2003.
(60) Provisional application No. 60/547,576, filed on Feb. 26, 2004.

(51) Int. Cl. A61H 1/02

(52) U.S. Cl. 601/1

(57) ABSTRACT

A skin cleansing and moisturizing device including a hand-held control wand that is detachably secured to a pad, one side of which is adapted to cleans the user's skin. A mechanical vibratory assembly is provided within the housing and imparts a vibratory motion to the pad. Additionally, a heat source is provided for heating the user's skin. The vibratory assembly may also apply suction to the skin through the pad.

This application claims the benefit of U.S. Provisional Application No. 60/496,695, which was filed Aug. 21, 2003, the disclosure of which is incorporated herein by this reference. This application also claims the benefit of U.S. Provisional Application No. 60/547,576, which was filed Feb. 26, 2004, the disclosure of which is incorporated herein by this reference. This application also claims the benefit of U.S. Provisional Application No. 60/508,235, which was filed Oct. 3, 2003, the disclosure of which is incorporated herein by this reference

### BACKGROUND AND SUMMARY OF THE INVENTION

The present invention relates to a skin treatment device and, more particularly, to a self contained, hand-held, battery operated, skin cleansing and moisturizing device.

The device provided in accordance with the invention is comprised of two components: a control wand that provides motion, heat, light, and/or a cleansing medium and a two-sided skin care pad as a disposable component that is selectively engaged with the control wand. The first side of the pad is adapted to provide deep cleaning, exfoliation and/or facial massage while conducting heat, light, vacuum, vibration and/or cleanser from the control wand to the user's skin. The second side of the pad is adapted for post cleansing massage, heating, and/or to apply moisturizer to the skin. It will be appreciated that in conjunction with the control wand, by engaging the first side of the pad with a target skin area, the device will provide a light buffing action to the skin's surface while the generated heat opens skin pores, the infrared light provides deep warming, the vacuum provides a suction pulling to remove unwanted oil and blackheads, and/or the vibration facilitates the loosening of material, thus facilitating the effective cleansing of the skin surface while reinvigorating the tissue. Likewise, engagement of the second pad surface to the skin provides moisturizing material as it is vibrated, which facilitates the take-up of moisturizers by the skin.

The foregoing and other objects of the invention are thus realized by providing a skin cleansing device comprising: a housing constructed and arranged to be grasped by hand; a removable pad for being detachably secured to a distal end of said housing, said pad having at least one surface adapted to face and selectively engage the user's skin, said skin engaging surface including a plurality of projecting micro fibrils; a power source mounted within said housing; a mechanical vibratory assembly within the housing for imparting a vibratory motion to said pad; and a heat source for heating the user's skin.

The invention may also be embodied in a skin cleansing and moisturizing device comprising: a housing constructed and arranged to be grasped by hand; a removable two-sided pad for being detachably secured to a distal end of said housing, each said side being adapted for contact with a user's skin; a power source mounted within said housing; a mechanical vibratory assembly within the housing to impart a vibratory motion to said pad; and a source of cleanser provided in said housing, on one side of said pad, or in said pad.

The invention may also be embodied in a skin cleansing device comprising: a housing constructed and arranged to be grasped by hand; an actuator tip projecting from a distal end of the housing; a removable two-sided pad for being detachably secured to said actuator tip; a power source mounted within said housing; an infrared light source disposed at a distal end of said housing for heating the user's skin; and a source of cleanser provided in said housing, on one side of said pad, or in said pad.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a schematic side view of a device embodying the invention exploded away from a power base and pad;

FIG. 2 is a schematic cross-sectional view of a control wand in accordance with the embodiment of FIG. 1;

FIG. 3 is a schematic perspective view of a two-sided cleansing and moisturizing pad embodying the invention;

FIG. 4 is an enlarged schematic cross-sectional view of a two-sided pad embodying the invention;

FIG. 5 is an enlarged schematic illustration of an embodiment of a micro surface architecture for the pad;

FIG. 6 is enlarged schematic illustration of another embodiment of a micro surface architecture for the pad;

FIG. 7 is a schematic illustration of yet another micro surface architecture, particularly adapted for with the moisturizing side of the pad.

### DETAILED DESCRIPTION OF THE INVENTION

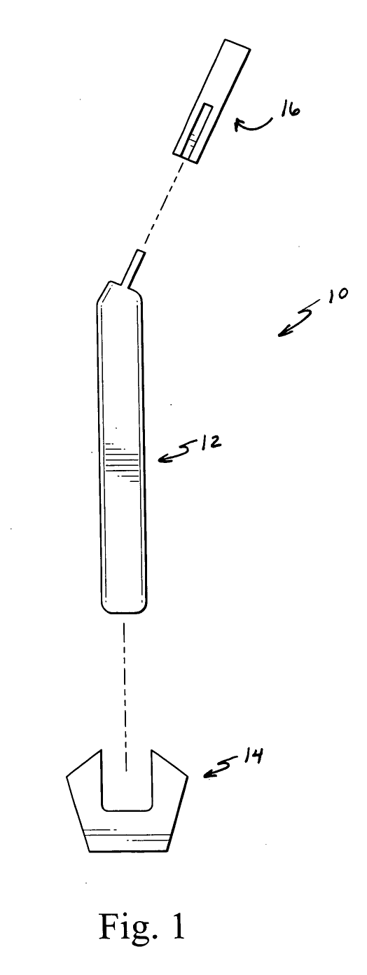

Referring now more particularly to FIG. 1, the invention provides a cleansing and moisturizing device 10 comprised of two components, a battery powered control wand 12 which is selectively operatively coupled to a recharger base 14 or which may include replaceable batteries, and a cleansing pad 16, illustrated exploded away from the control wand. As described in greater detail below, in a presently preferred embodiment, the pad 16 is two-sided: a first side 18 of the pad being adapted to provide deep cleaning, facial massage, and/or heat for cleansing the skin; the second side 20 of the pad being adapted to massage and moisturize the cleansed skin.

The control wand 12 includes a housing 22 constructed and arranged to be grasped by hand. The housing may be provided with a surface texturing pattern for ease of handling. The surface texturing may also be adapted to aid the user in properly orientating the wand with respect to the face for cleansing or moisturizing actions. The distal end 24 of the housing comprises an actuator tip 26 configured and adapted to engage and temporarily attach to the disposable pad 16 to the control wand 12. The preferred implementation is a snap type of attachment of the pad to the wand. For example, the distal end of the housing may have a pair of detents on either side of the portion adapted to engage the pad. Two corresponding, flexible arms may be provided on the pad to engage the detents and lock the pad onto the housing. Pulling on the pad with sufficient force will disengage the pad. A friction or other locking fit is also possible. In the illustrated embodiment, the actuator tip 26 is disposed of angle of, e.g., 10 to 30 degrees with respect to the longitudinal axis of the control wand 12, although it is to be understood that the actuator tip may be axially aligned with the longitudinal axis of the control wand.

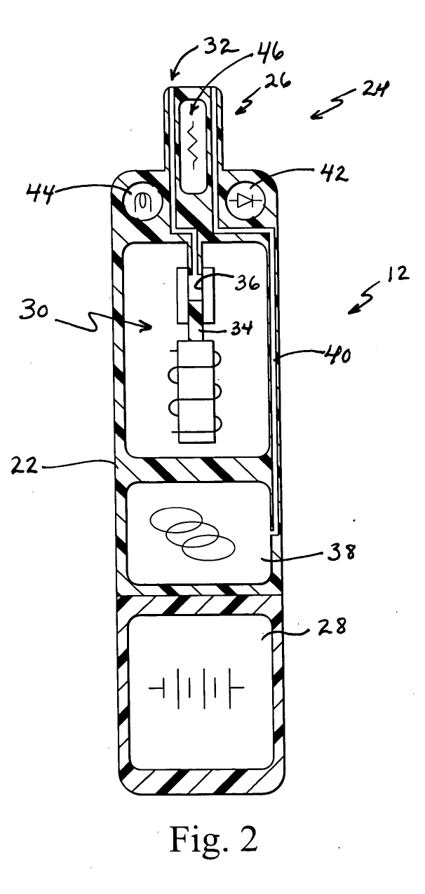

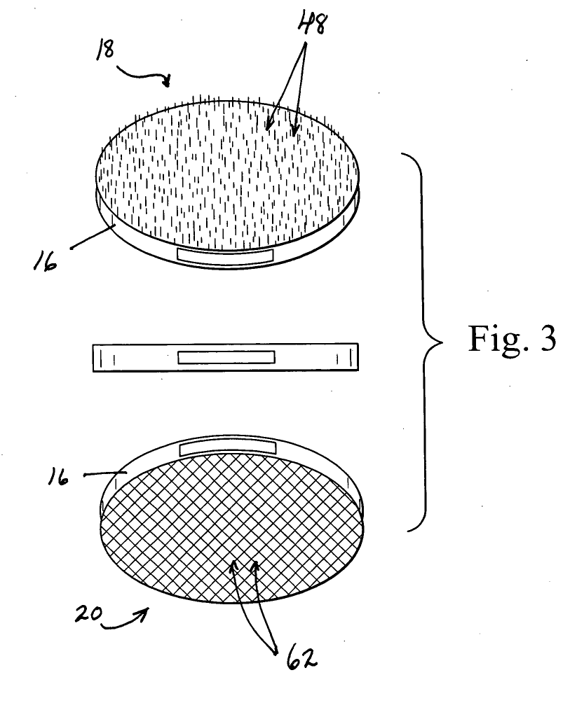

Referring to FIG. 2, contained within the control wand 12 is a battery power source 28. The battery power source may be replaceable batteries accessed through a detachable panel (not shown) in the side wall or base of the housing 22 or may be a rechargeable battery that is selectively recharged by placing the control wand in the power base 14 as schematically illustrated in FIG. 1. Such battery powered hand held units are well known from the conventional electric toothbrush and sonic toothbrush arts and may be readily adapted to the control wand of the cleansing and moisturizing device 10 of the invention. The components of the device, which are described in greater detail below, are selectively actuated by one or more control on/off button(s) or switch(es) (not shown) provided in the side wall of the housing 22. If deemed necessary or desirable, the controls may be constructed and arranged to provide simultaneous or individual actuation of one or more of the functions of the wand in a known manner.

A mechanical vibratory assembly 30 is disposed within the housing and operatively coupled to, e.g., the actuator tip 26 to impart a vibratory motion to the actuator tip. In an exemplary embodiment, the vibratory assembly concurrently defines a vacuum assembly for cyclically providing suction and expulsion through a passage 32 in the actuator tip. The suction pressure and expulsion, as well as vibration, may be generated by a simple mechanical assembly, such as a reciprocating plunger 34 as schematically shown. More particularly, a magnetic actuator (a solenoid) reciprocates/vibrates a piston (which may be a dowel pin). This piston moves in a cylindrical cavity 36. There are two results of the piston moving in the cavity. First, the entire control wand is caused to vibrate by the motion of the piston. Second, the piston in the cavity generates a vacuum on the down stroke and positive pressure on the up stroke. Passage 32 conducts this vacuum/positive pressure to the pad 16 where openings in the pad apply this pressure variation to the skin surface. Applications of a vacuum to the skin helps pull out material such as black heads and other pore clogging debris. If deemed necessary or desirable, a filter membrane (not shown) may be provided downstream of the reciprocating plunger 34 to protect the plunger and other components of the vacuum generating assembly from aspirated materials.

The skin cleansing device may further comprise a source of cleanser. The cleanser may be provided on or in the pad, as described more particularly below, and/or a cleanser source or generator 38 may be disposed within the housing. In a presently preferred embodiment, cleanser is contained in the pad and surface tension is used to control the flow of cleanser to the face. Reservoirs in the pad hold fluids and narrow channels allow the fluid to flow, aided by surface tension and delayed by viscosity. The combination of surface tension and viscosity allows the liquids to be dispensed at the proper rate, in a manner analogous to the way in which a felt tip pen uses surface tension and viscosity to provide a controlled flow of fluid to the surface it engages.

In one advantageous embodiment, the cleanser source 38 provided within the housing is a hydrogen peroxide generator, although a cleanser reservoir or another type of cleanser generator may be provided in its stead. An exemplary micro hydrogen generator is disclosed in U.S. Provisional Application No. 60/508,235, filed Oct. 3, 2003, the disclosure of which is incorporated herein by this reference. As schematically illustrated, one or more passages 40 are defined through the control wand from the cleanser source/generator to and through the actuator tip and to the surface of the pad. In the case of a hydrogen peroxide generator, it contains dissolved hydrogen and oxygen gas. This hydrogen and oxygen produces bubbles which produce a pressure and propel the hydrogen peroxide into the pad for being dispensed to the skin. In addition or in the alternative, a suitable pump structure may be incorporated in the control wand.

In an embodiment of the invention, at least one heat source is provided, to heat the user's skin, the cleanser, and/or the actuator tip. In an exemplary embodiment there are two sources of heat. One is a light source. The light source can be a Light Emitting Diode (LED) 42 or could be a light bulb 44. The light source is advantageously primarily infrared radiation, IR, to allow deep penetration and heating of the skin, to provide a warm sensation and to enhance cleansing. If a light bulb is used, it is run at a voltage lower than its design voltage to enhance the ratio of IR to visible light. One may also wish to provide a visible color such as red light so the consumer can see the region of the face surrounding the pad glow. An LED would be suitable for this visible color or if a light bulb is used, it will provide some red light. Thus the heat source may comprise a heat emitting light source to thereby provide the dual function of heating, e.g., to invigorate the skin, open pores, facilitate cleanser flow, etc., and illuminating, e.g., to allow the user to see the area being treated and/or determine whether further treatment or other special attention is required. In the illustrated embodiment, light source(s) are provided at the distal end of the housing adjacent the actuator tip, preferably at least on the cleansing side of the hand held device.

In addition or in the alternative, the heat source is a more traditional resistor-type heater 46 disposed within the housing or actuator tip. A temperature controller may be provided to control the temperature and/or the heater is provided by a small amount of power, such as ¼ to 1 watt and the surrounding air will keep the pad from becoming too hot.

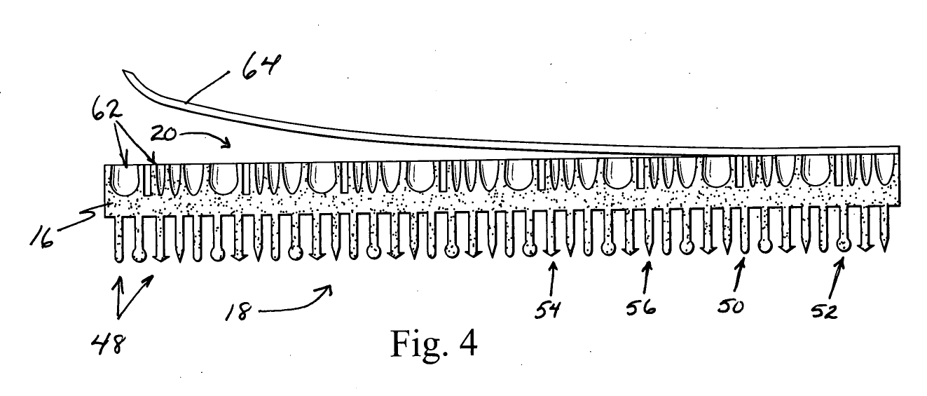

FIG. 4 illustrates a pad 16 provided in accordance with an embodiment of the invention in schematic cross-sectional view. In an exemplary embodiment the pad is about ¾ inch by about 1 inch and about ⅛ to ¼ inches thick. As illustrated, one side 18 of the pad includes a plurality of micro fibrils 48 and includes passages (not shown in detail) for conducting cleanser from a cleanser source within the pad, or from the control wand housing through the actuator tip, to the surface of the pad for application to the skin. The width of the micro passages typically ranges from a few microns to a few tens of microns in width. Passages (not shown in detail) are also provided for communicating the pressure changes generated by the vacuum source to the pad surface. The micro fibrils provide a delicate yet effective scrubbing action for cleansing the skin upon vibration of the pad. Also, heat generated by the lamp and/or internal heater is conducted to the skin surface thereby opening the skin pores, reinvigorating the skin, and cleansing the skin surface.

In a preferred embodiment the pad 16 is solid, made using micro molding techniques, with micro passages molded into the body of the pad and with the eternal fibrils 48 molded with the body of the pad, as an integral feature of the pad. An example of such micro molding techniques is the replication of masters in the LIGA processes developed in Germany. In those processes, a PMMA plastic is coated over the master and when it is cured it has a sub micron resolution (a millionth of a meter). The process for forming the pad of the invention requires a less demanding, few micron resolution, since the smallest structures will typically be a few microns. One can also use the photolithographic techniques of the electronics industry and the SU-8 polymer to photolithographically define the small features. Conventional molding techniques are also approaching the resolution needed to mold the pads. For example, the American Laubscher company has plastic molded micro gratings with sub micron resolution.

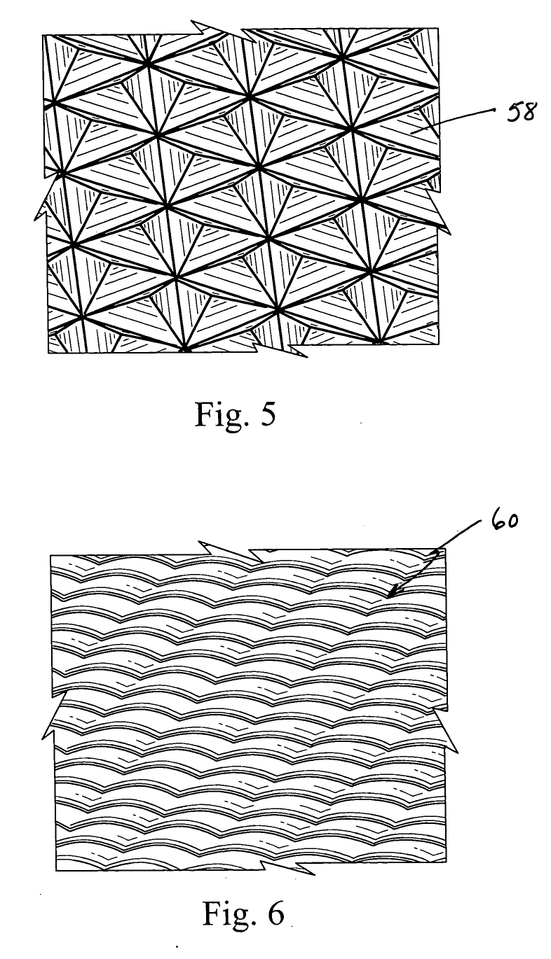

FIG. 4 schematically depicts by way of example several micro fibril tip configurations that may be integrally provided at the tips of the micro fibrils, in the alternative or in combination, namely, a finger tip 50, a ball tip 52, a snell tip 54 and a squeegee configuration 56. As an alternative to, or in addition to micro fibrils 48 as illustrated, a micro surface architecture 58, 60 may be provided such as illustrated by way of example in FIG. 5 and/or FIG. 6, respectively.

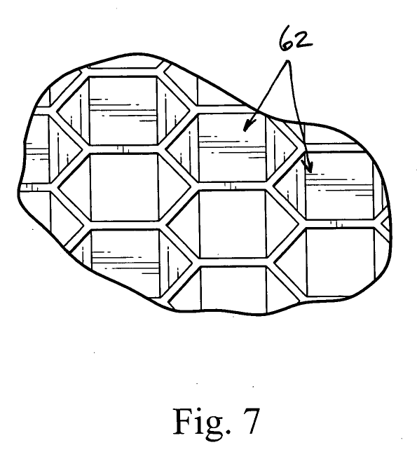

The other side 20 of the pad is adapted to contain a moisturizer, e.g., in a plurality of micro capsules 62, as schematically illustrated in FIG. 4 and in greater detail by way of example in FIG. 7. To maintain the moisturizer in the micro capsules before use, and to prevent the moisturizer from drying out, the filled micro capsules can be covered by a suitable cover film or membrane 64, as schematically shown in FIG. 4, which is removed prior to use. The size of the capsules and viscosity of the moisturizer are varied to provide a convenient flow of moisturizer to the skin. The micro capsules will typically have a width of one to several hundred microns. In the alternative, a source of moisturizer may be provided in the control wand along with a suitable pump or other mechanism for dispensing the moisturizer to the pad. As yet a further alternative, the user can apply moisturizer to the surface of the pad before use. The device's heater can also be used during moisturizer application to reduce the viscosity of the moisturizer and enhance penetration of the moisturizer on application.

To use the cleansing device, the user attaches the pad to the distal end of the control wand, such as by inserting the actuator tip of the control wand into the corresponding receptacle of a two sided pad, thus removably locking, e.g., with a snap action, the pad on to the wand for a cleansing session. The device is then actuated for cleansing the face by actuating, e.g., the hydrogen peroxide micro generator or other cleanser source, heater and/or vibratory assemblies and disposing the first side 18 of the pad in contact with the skin so that the scrubbing action of the micro fibrils 48 effectively distributes the cleanser, and removes oils and debris from the skin surface.

The hydrogen peroxide comes from the wand and would need to be recharged periodically. In the preferred embodiment, the package of pads also has a capsule, which contains water and chemicals for generating hydrogen peroxide and/or other cleansing fluids, which inserts into the wand for use with the pads in the package. The other cleansers and moisturizers are preferably in the pad and are the correct concentration as packaged. Once the cleansing has concluded, the user may rinse the skin if deemed necessary or desirable, to remove the disrupted dirt and spent cleanser. Preferably, however, the user will not need to wash off their face after cleansing with a pad. But the user may wish to use other products after using the pad. In any event, once cleansing has been completed, the user is then ready to apply moisturizer. To do so, the cover 64, if any, disposed over the moisturizing side of the pad is removed, the control wand is then rotated 180° to dispose the second side 20 of the pad in opposed facing relation to the skin. The control wand is then actuated to distribute the moisturizer onto the skin. Providing a micro architecture, e.g., as illustrated in FIGS. 5 and 6, on at least a part of the moisture application side of the pad helps to apply the moisturizing fluid and smooth the skin.

Once the moisturizer application has been completed, the used pad 16 is disengaged from the actuator tip of the device and the disposed in the trash. The wand 12 may then be returned to its storage/power base 14, to recharge for subsequent uses.

As will be appreciated from the foregoing, the heated micro vibrating micro fibrils provide deep pore cleansing and remove the sebum from pores. They also massage the area to increase blood circulation and remove dead facial cells providing a deep cleansing. The illuminator provided at the distal end of the housing provides warming of the epidermis in lieu of or as a supplement to the heater of the control wand, facilitating removal of sebaceous oils and waxes as well as dead skin. The micro fibrils may be of varying length and width thereby allowing micro penetration of the pores. In an exemplary embodiment of the invention, the device uses micro generation of hydrogen peroxide in the wand to provide a cleansing fluid for the pad. The motion of the heated micro fibrils provides an excellent micro massage and when accompanied by a cleanser such as hydrogen peroxide provides a clean feeling and great sensation. It is also to be appreciated that increasing the hydrogen peroxide concentration can enable bleaching of unwanted pigmentations and dark facial hair.

Additionally, the pad may be used to apply agents, such as sun block, medication, small amounts of expensive facial cream and other medicaments, to the skin, in addition to or as an alternative to moisturizers. Thus, as an alternative to, or in addition to incorporating moisturizers in the second face of the pad, the consumer may apply a small amount of another fluid to the surface of the pad.

Moreover, different regions of the pad can contain different compounds or lotions. The different regions can be sealed so that they do not interact with one another in advance of application to the skin. Furthermore, the various materials may be combined on application to the skin or just by removing the film. This may be advantageous because some compounds cannot be stored together for extended periods but provide a beneficial effect if they are combined just before use. Different regions may be provided with different compounds by a variety of techniques. For example, the different compounds may be provided at distinct places on the pad during manufacturing using surface tension and appropriate channels the compounds may be located and maintained in desired areas. In addition, or in the alternative, a suitable applicator may be used to deposit the appropriate compound at the appropriate place(s) on the pad. The viscosity of the component and the size of passages for conducting the material to the surface of the pad can then control the rate of delivery of the materials. In this regard, in a several millimeter area one can have hundreds or thousands of micro channels, each channel delivering fluid. In a micro system, such as proposed for the pad surface embodying the invention, the fluid need only flow a short distance. A hundred microns is a typical micro channel depth (a human hair is about 70 microns in diameter). The pad of the invention has many thousands of micro wicking channels in contact with the skin delivering appropriate fluids.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A skin cleansing device comprising:
a housing constructed and arranged to be grasped by hand;
a removable pad for being detachably secured to a distal end of said housing, said pad having at least one surface adapted to face and selectively engage the user's skin, said skin engaging surface including a plurality of projecting micro fibrils;
a power source mounted within said housing;
a mechanical vibratory assembly within the housing for imparting a vibratory motion to said pad; and
a heat source for heating the user's skin.

2. A skin cleansing device as in claim 1, wherein said a mechanical vibratory assembly includes a vacuum assembly for cyclically providing suction and expulsion force to said skin engaging surface.

3. A skin cleansing device as in claim 1, further comprising a cleanser disposed on said skin engaging surface.

4. A skin cleansing and moisturizing device comprising:
a housing constructed and arranged to be grasped by hand;
a removable two-sided pad for being detachably secured to a distal end of said housing, each said side being adapted for contact with a user's skin;
a power source mounted within said housing;
a mechanical vibratory assembly within the housing to impart a vibratory motion to said pad; and
a source of cleanser provided in said housing, on one side of said pad, or in said pad.

5. A skin cleansing and moisturizing device as in claim 4, further comprising a heat source for heating the user's skin, said cleanser and/or said actuator tip.

6. A skin cleansing and moisturizing device as in claim 4, wherein said a mechanical vibratory assembly includes a vacuum assembly for cyclically providing suction and expulsion.

7. A skin cleansing and moisturizing device as in claim 4, wherein said heat source comprises a light source disposed on said distal end of said housing.

8. A skin cleansing and moisturizing device as in claim 4, wherein said power source comprises a rechargeable battery.

9. A skin cleansing and moisturizing device as in claim 8, in combination with a power base for re-charging said battery.

10. A skin cleansing and moisturizing device as in claim 4, wherein said two-sided pad is frictionally engaged with said actuator tip.

11. A skin cleansing and moisturizing device as in claim 4, wherein said one side of said pad comprises a plurality of micro fibrils for providing a scrubbing action upon vibration of the actuator tip.

12. A skin cleansing and moisturizing device as in claim 11, wherein said micro fibrils have a tip configuration selected from the group consisting of finger, ball, snell, and squeegee.

13. A skin cleansing and moisturizing device as in claim 11, wherein said one side of said pad further includes at least one passage for conducting cleanser to the surface of the pad.

14. A skin cleansing and moisturizing device as in claim 4, wherein said other side of said pad comprises a plurality of micro capsules, said micro capsules having a moisturizer disposed therewithin.

15. A skin cleansing and moisturizing device as in claim 14, wherein said microcapsules are sealed with a removable cover film or membrane.

16. A skin cleansing device comprising:
a housing constructed and arranged to be grasped by hand;
an actuator tip projecting from a distal end of the housing;
a removable two-sided pad for being detachably secured to said actuator tip;
a power source mounted within said housing;
an infrared light source disposed at a distal end of said housing for heating the user's skin; and
a source of cleanser provided in said housing, on one side of said pad, or in said pad.

17. A skin cleansing device as in claim 16, wherein said one side of said pad comprises a plurality of micro fibrils for providing a scrubbing action upon vibration of the actuator tip.

18. A skin cleansing device as in claim 17, wherein said micro fibrils have a tip configuration selected from the group consisting of finger, ball, snell, and squeegee.

19. A skin cleansing device as in claim 17, wherein said one side of said pad further includes at least one passage for conducting cleanser to the surface of the pad.

20. A skin cleansing device as in claim 17, wherein said other side of said pad comprises a plurality of micro capsules, said micro capsules having a moisturizer disposed therewithin.
